(19) United States
(12) Patent Application Publication
(10) Pub. No.: US 2026/0209011 A1
(43) Pub. Date: Jul. 23, 2026

(54) CONTAINER HANDLING VEHICLE AND STORAGE SYSTEM

(71) Applicant: AutoStore Technology AS, Nedre Vats (NO)

(72) Inventor: Trond Austrheim, Etne (NO)

(21) Appl. No.: 19/140,292

(22) PCT Filed: Nov. 27, 2023
(86) PCT No.: PCT/EP2023/083219

§ 371 Date: Jun. 17, 2025

(30) Foreign Application Priority Data
Dec. 20, 2022 (NO) 20221375

(51) Int. Cl. B66C 19/00; B65G 1/04

(52) U.S. Cl. CPC B66C 19/00; B65G 1/0464

(57) ABSTRACT

The present invention provides a container handling vehicle (501,601) for picking up storage containers (106) in a storage system (1), the storage system comprising a framework structure (100) having a plurality of storage columns (105) for accommodating a vertical stack of storage containers (106), and a rail system (108) upon which the vehicle may move in two perpendicular directions above the storage columns, the container handling vehicle comprising a vehicle body (6) and at least one lifting device for lifting a storage container (106) from any of the storage columns (105); the lifting device comprises a horizontal lifting frame (2) suspended from the vehicle body (6) by a plurality of lifting bands (5), the lifting bands are connected to at least one rotatable lifting shaft (8) such that the lifting frame may be moved in a vertical direction between an upper position and a lower position relative to the vehicle body; the container handling vehicle features a lifting frame stopper arrangement comprising a plurality of first stoppers (9,20) connected to the vehicle body (6) at positions above the lifting frame (2) and a plurality of cooperating second stoppers (10) arranged at an upper face (24) of the lifting frame; and each of the first stoppers (9,20) and the cooperating second stopper (10) are configured to engage one another to stop vertical upward movement of the lifting frame when the lifting frame is in the upper position.

### FIELD OF THE INVENTION

The present invention relates to a container handling vehicle and a storage system comprising the container handling vehicle.

### BACKGROUND AND PRIOR ART

FIG. 1 discloses a prior art automated storage and retrieval system 1 (i.e. a storage system), with a framework structure 100 and FIGS. 2, 3 and 4 disclose three different prior art container handling vehicles 201,301,401 suitable for operating on such a system 1.

The framework structure 100 comprises upright members 102 and a storage volume comprising storage columns 105 arranged in rows between the upright members 102. In these storage columns 105 storage containers 106, also known as bins, are stacked one on top of one another to form stacks 107. The members 102 may typically be made of metal, e.g. extruded aluminium profiles.

The framework structure 100 of the automated storage and retrieval system 1 comprises a rail system 108 (i.e. a rail grid) arranged across the top of framework structure 100, on which rail system 108 a plurality of container handling vehicles 201,301,401 may be operated to raise storage containers 106 from, and lower storage containers 106 into, the storage columns 105, and also to transport the storage containers 106 above the storage columns 105. The rail system 108 comprises a first set of parallel rails 110 arranged to guide movement of the container handling vehicles 201,301,401 in a first direction X across the top of the frame structure 100, and a second set of parallel rails 111 arranged perpendicular to the first set of rails 110 to guide movement of the container handling vehicles 201,301,401 in a second direction Y which is perpendicular to the first direction X. Containers 106 stored in the columns 105 are accessed by the container handling vehicles 201,301,401 through access openings 112 in the rail system 108. The container handling vehicles 201,301,401 can move laterally above the storage columns 105, i.e. in a plane which is parallel to the horizontal X-Y plane.

The upright members 102 of the framework structure 100 may be used to guide the storage containers during raising of the containers out from and lowering of the containers into the columns 105. The stacks 107 of containers 106 are typically self-supportive.

Each prior art container handling vehicle 201,301,401 comprises a vehicle body 201a,301a,401a and first and second sets of wheels 201b,201c,301b,301c,401b,401c which enable the lateral movement of the container handling vehicles 201,301,401 in the X direction and in the Y direction, respectively. In FIGS. 2, 3 and 4 two wheels in each set are fully visible. The first set of wheels 201b,301b,401b is arranged to engage with two adjacent rails of the first set 110 of rails, and the second set of wheels 201c,301c,401c is arranged to engage with two adjacent rails of the second set 111 of rails. At least one of the sets of wheels 201b,301b,201c,301c,401b,401c can be lifted and lowered, so that the first set of wheels 201b,301b,401b and/or the second set of wheels 201c,301c,401c can be engaged with the respective set of rails 110, 111 at any one time.

Each prior art container handling vehicle 201,301,401 also comprises a lift device 404, see FIG. 4, for vertical transportation of storage containers 106 (i.e. a container lift device), e.g. raising a storage container 106 from, and lowering a storage container 106 into, a storage column 105. The lift device 404 features a lifting frame 2 comprising container connectors 3, adapted to engage connecting recesses 13 at an upper rim of the sidewalls 14 of a storage container 106, see FIG. 5, and guiding pins 4. The guiding pins 4 are arranged to interact with guiding pin recesses 7 at the corners of the storage container and ensure a correct alignment of the lifting frame 2 and container connectors 3 relative to the storage container. The guiding pins 4 will also assist in guiding the lifting frame 2 relative to the upright members of the storage column 105. The lifting frame 2 can be lowered from the vehicle 201,301,401 so that the position of the lifting frame 2 with respect to the vehicle 201,301,401 can be adjusted in a third direction Z which is orthogonal the first direction X and the second direction Y. The lifting device of the container handling vehicle 201 is located within the vehicle body 201a in FIG. 2.

To raise or lower the lifting frame 2 (and optionally a connected storage container 106), the lifting frame 2 is suspended from a band drive assembly by lifting bands 5. In the band drive assembly, the lifting bands are commonly spooled on/off at least one rotating lifting shaft or reel arranged in the container handling vehicle. Various designs of band drive assemblies are described in for instance WO 2015/193278 A1, WO 2017/129384 A1 and WO 2019/206438 A1.

Conventionally, and also for the purpose of this application, Z=1 identifies the uppermost layer for storing storage containers below the rail system 108, i.e. the layer immediately below the rail system 108, Z=2 the second layer below the rail system 108, Z=3 the third layer etc. In the exemplary prior art disclosed in FIG. 1, Z=8 identifies the lowermost, bottom layer of storage containers. Similarly, X=1 . . . n and Y=1 . . . n identifies the position of each storage column 105 in the horizontal plane. Consequently, as an example, and using the Cartesian coordinate system X, Y, Z indicated in FIG. 1, the storage container identified as 106′ in FIG. 1 can be said to occupy storage position X=17, Y=1, Z=6. The container handling vehicles 201,301,401 can be said to travel in layer Z=0, and each storage column 105 can be identified by its X and Y coordinates. Thus, the storage containers shown in FIG. 1 extending above the rail system 108 are also said to be arranged in layer Z=0.

The storage volume of the framework structure 100 has often been referred to as a grid 104, where the possible storage positions within this grid are referred to as storage cells. Each storage column may be identified by a position in an X- and Y-direction, while each storage cell may be identified by a container number in the X-, Y- and Z-direction.

Each prior art container handling vehicle 201,301,401 comprises a storage compartment or space for receiving and stowing a storage container 106 when transporting the storage container 106 across the rail system 108. The storage space may comprise a cavity arranged internally within the vehicle body 201a as shown in FIGS. 2 and 4 and as described in e.g. WO2015/193278A1 and WO2019/206487A1, the contents of which are incorporated herein by reference.

FIG. 3 shows an alternative configuration of a container handling vehicle 301 with a cantilever construction. Such a vehicle is described in detail in e.g. NO317366, the contents of which are also incorporated herein by reference.

The cavity container handling vehicles 201 shown in FIG. 2 may have a footprint that covers an area with dimensions in the X and Y directions which is generally equal to the lateral extent of a storage column 105, e.g. as is described in WO2015/193278A1, the contents of which are incorporated herein by reference. The term ‘lateral’ used herein may mean ‘horizontal’.

Alternatively, the cavity container handling vehicles 401 may have a footprint which is larger than the lateral area defined by a storage column 105 as shown in FIGS. 1 and 4, e.g. as is disclosed in WO2014/090684A1 or WO2019/206487A1.

The rail system 108 typically comprises rails with grooves in which the wheels of the vehicles run. Alternatively, the rails may comprise upwardly protruding elements, where the wheels of the vehicles comprise flanges to prevent derailing. These grooves and upwardly protruding elements are collectively known as tracks. Each rail may comprise one track, or each rail may comprise two parallel tracks.

WO2018/146304A1, the contents of which are incorporated herein by reference, illustrates a typical configuration of rail system 108 comprising rails and parallel tracks in both X and Y directions forming a rail grid.

In the framework structure 100, most of the columns 105 are storage columns 105, i.e. columns 105 where storage containers 106 are stored in stacks 107. However, some columns 105 may have other purposes. In FIG. 1, columns 119 and 120 are such special-purpose columns used by the container handling vehicles 201,301,401 to drop off and/or pick up storage containers 106 so that they can be transported to an access station (not shown) where the storage containers 106 can be accessed from outside of the framework structure 100 or transferred out of or into the framework structure 100. Within the art, such a location is normally referred to as a ‘port’ and the column in which the port is located may be referred to as a ‘port column’ 119,120. The transportation to the access station may be in any direction, that is horizontal, tilted and/or vertical. For example, the storage containers 106 may be placed in a random or dedicated column 105 within the framework structure 100, then picked up by any container handling vehicle and transported to a port column 119,120 for further transportation to an access station. Note that the term ‘tilted’ means transportation of storage containers 106 having a general transportation orientation somewhere between horizontal and vertical.

In FIG. 1, the first port column 119 may for example be a dedicated drop-off port column where the container handling vehicles 201,301,401 can drop off storage containers 106 to be transported to an access or a transfer station, and the second port column 120 may be a dedicated pick-up port column where the container handling vehicles 201,301,401 can pick up storage containers 106 that have been transported from an access or a transfer station.

The access station may typically be a picking or a stocking station where product items are removed from or positioned into the storage containers 106. In a picking or a stocking station, the storage containers 106 are normally not removed from the automated storage and retrieval system 1 but are returned into the framework structure 100 again once accessed. A port can also be used for transferring storage containers to another storage facility (e.g. to another framework structure or to another automated storage and retrieval system), to a transport vehicle (e.g. a train or a lorry), or to a production facility.

A conveyor system comprising conveyors is normally employed to transport the storage containers between the port columns 119,120 and the access station.

If the port columns 119,120 and the access station are located at different levels, the conveyor system may comprise a lift device with a vertical component for transporting the storage containers 106 vertically between the port column 119,120 and the access station.

The conveyor system may be arranged to transfer storage containers 106 between different framework structures, e.g. as is described in WO2014/075937A1, the contents of which are incorporated herein by reference.

When a storage container 106 stored in one of the storage columns 105 disclosed in FIG. 1 is to be accessed, one of the container handling vehicles 201,301,401 is instructed to retrieve the target storage container 106 from its position and transport it to the drop-off port column 119. This operation involves moving the container handling vehicle 201,301,401 to a location above the storage column 105 in which the target storage container 106 is positioned, retrieving the storage container 106 from the storage column 105 using the container handling vehicle's 201,301,401 lifting device 404, and transporting the storage container 106 to the drop-off port column 119. If the target storage container 106 is located deep within a stack 107, i.e. with one or a plurality of other storage containers 106 positioned above the target storage container 106, the operation also involves temporarily moving the above-positioned storage containers prior to lifting the target storage container 106 from the storage column 105. This step, which is sometimes referred to as “digging” within the art, may be performed with the same container handling vehicle that is subsequently used for transporting the target storage container to the drop-off port column 119, or with one or a plurality of other cooperating container handling vehicles. Alternatively, or in addition, the automated storage and retrieval system 1 may have container handling vehicles 201,301,401 specifically dedicated to the task of temporarily removing storage containers 106 from a storage column 105. Once the target storage container 106 has been removed from the storage column 105, the temporarily removed storage containers 106 can be repositioned into the original storage column 105. However, the removed storage containers 106 may alternatively be relocated to other storage columns 105.

When a storage container 106 is to be stored in one of the columns 105, one of the container handling vehicles 201,301,401 is instructed to pick up the storage container 106 from the pick-up port column 120 and transport it to a location above the storage column 105 where it is to be stored. After any storage containers 106 positioned at or above the target position within the stack 107 have been removed, the container handling vehicle 201,301,401 positions the storage container 106 at the desired position. The removed storage containers 106 may then be lowered back into the storage column 105 or relocated to other storage columns 105.

For monitoring and controlling the storage system 1, e.g. monitoring and controlling the location of respective storage containers 106 within the framework structure 100, the content of each storage container 106, and the movement of the container handling vehicles 201,301,401 so that a desired storage container 106 can be delivered to the desired location at the desired time without the container handling vehicles 201,301,401 colliding with each other, the storage 1 comprises a control system 500 which typically is computerized and which typically comprises a database for keeping track of the storage containers 106.

Each of the storage containers 106 in the storage system 1 has a horizontal periphery configured to fit within the cross-sectional area of the storage columns 105. However, the height of the storage containers may be varied, e.g. depending on the type of items that is to be stored in the storage system. All the storage containers in a given storage system are commonly of the same height to facilitate the monitoring and operation of the storage system. The prior art container handling vehicles are configured to lift storage containers of different heights but are not optimized for lifting storage containers having a height being lower than a maximum container height of the container handling vehicles.

An object of the present invention is to provide a container handling vehicle that may easily be optimized for use with storage containers of different heights to improve time and energy sufficiency.

### SUMMARY OF THE INVENTION

The present invention is defined by the attached claims and in the following:

In a first aspect, the present invention provides a container handling vehicle for picking up storage containers in a storage system, the storage system comprising a framework structure having a plurality of storage columns for accommodating a vertical stack of storage containers, and a rail system upon which the vehicle may move in two perpendicular directions above the storage columns, the container handling vehicle comprising a vehicle body and at least one lifting device for lifting a storage container from any of the storage columns;
the lifting device comprises a horizontal lifting frame suspended from the vehicle body by a plurality of lifting bands, the lifting bands are connected to at least one rotatable lifting shaft such that the lifting frame may be moved in a vertical direction between an upper position and a lower position relative to the vehicle body;
the container handling vehicle features a lifting frame stopper arrangement comprising a plurality of first stoppers connected to the vehicle body at positions above the lifting frame and a plurality of cooperating second stoppers arranged at an upper face of the lifting frame; and
each of the first stoppers and the cooperating second stopper are configured to engage one another to stop vertical upward movement of the lifting frame when the lifting frame is in the upper position.

The first stoppers may be connected directly or indirectly to the vehicle body. The first stoppers may also be defined as being rigidly connected relative to the vehicle body.

In an embodiment of the container handling vehicle, at least a part of each first stopper or each second stopper may be removeable, or replaceable by a corresponding part having a different height, or each of the first stopper or second stopper may be extendable in a vertical direction, such that the level of the lifting frame when in the upper position may be adjusted.

In an embodiment of the container handling vehicle, at least one of the first stoppers or the second stoppers may be coupled with a sensor for detecting when the first and second stopper engage one another; the sensor may be in communication with a control system of the vehicle such that rotation of the at least one rotatable lifting shaft is stopped when the lifting frame is in the upper position.

In an embodiment of the container handling vehicle, each of the first stoppers may comprise a pin having a first end and a second end, the pin may be connected to the vehicle body at the first end and the second end may be arranged for interaction and/or engagement with the cooperating second stopper when the lifting frame is in the upper position.

In an embodiment of the container handling vehicle, the vehicle body may comprise a cantilevered section below which the lifting frame is suspended.

In an embodiment of the container handling vehicle, each of the first stoppers and the corresponding second stopper may be configured for sliding engagement, such that horizontal movement of the lifting frame relative to the vehicle body is prevented when the lifting frame is in the upper position.

In an embodiment of the container handling vehicle, the second end of the first stopper may comprise a recess or tip configured to interact with a corresponding tip or recess, respectively, of the second stopper, such that horizontal movement of the lifting frame relative to the vehicle body is prevented when the lifting frame is in the upper position.

In an embodiment of the container handling vehicle, the second stopper may comprise a spring-loaded pin, the pin being connected to a sensor for detecting when the first stopper and the second stopper is in engagement and the lifting frame is in the upper position.

In an embodiment of the container handling vehicle, the lifting frame may comprise gripper elements for releasable connection to a storage container, wherein each corner of the lifting frame is provided with a second stopper.

In an embodiment of the container handling vehicle, the first stopper comprises a bracket connected to the vehicle body. The bracket may comprise an interface for engagement with a corresponding second stopper and/or an interface for releasable attachment of a pin.

In an embodiment of the container handling vehicle, the first stopper comprises a pin, and the pin is releasable attached to the bracket.

In a second embodiment, the present invention provides a storage system comprising a container handling vehicle according to any embodiment of the first aspect, a framework structure having a plurality of storage columns accommodating a vertical stack of storage containers, and a rail system upon which the vehicle may move in two perpendicular directions above the storage columns.

In an embodiment of the storage system, at least a part of each first stopper or each second stopper may be removeable, or replaceable by a corresponding part having a different height, or each of the first stopper or second stopper is extendable in a vertical direction, such that the level of the lifting frame when in the upper position may be adjusted between a first level and a second level, the first level being higher than the second level;
the storage containers may be of a first type or a second type, the first type and the second type having a height difference; and
the height difference being equal to a height difference between the first level and the second level.

In a third embodiment, the present invention provides a method of optimizing a container handling vehicle according to any embodiment of the first aspect for use in a storage system according to any embodiment of the second aspect in which vertical stacks of the first type of storage containers are to be replaced by vertical stacks of the second type of storage containers; the method comprising the steps of:
adjusting the level of the lifting frame when in the upper position from the second level to the first level by:
   removing at least one part of the first stopper or the second stopper; or
   replacing at least one part of the first stopper or the second stopper by a corresponding part having a different height; or
   retracting at least one part of the first stopper or the second stopper in a vertical direction.

### BRIEF DESCRIPTION OF THE DRAWINGS

Embodiments of the invention is described in detail by reference to the following drawings:

FIG. 1 is a perspective view of a framework structure of a prior art automated storage and retrieval system.

FIG. 2 is a perspective view of a prior art container handling vehicle having a centrally arranged cavity for carrying storage containers therein.

FIG. 3 is a perspective view of a prior art container handling vehicle having a cantilevered section for carrying storage containers underneath.

FIG. 4 is a perspective view of a prior art container handling vehicle, wherein a container lifting assembly is shown.

FIG. 5 is a perspective view of a storage container as used in the storage system in FIG. 1.

FIGS. 6 and 7 show a first exemplary container handling vehicle according to the invention.

FIGS. 8-11, 13 and 15 show a second exemplary container handling vehicle according to the invention.

FIGS. 12 and 14 show a third exemplary container handling vehicle according to the invention.

### DETAILED DESCRIPTION OF THE INVENTION

In the following, embodiments of the invention will be discussed in more detail with reference to the appended drawings. The drawings are not intended to limit the invention to the illustrated subject-matter.

As discussed above, a storage system 1 may feature storage containers 106 of different heights. The storage containers 106 used in a specific framework structure 100 will commonly be of the same height to simplify processing and control of the storage system. To allow for a change of the height of the storage containers 106 used in a storage system, the prior art container handling vehicles 201,301,401 are configured to lift storage containers of different heights, up to a maximum container height, without requiring any modification of the vehicle.

In the prior art container handling vehicles 201,301,401, the lifting frame 2 and an upper rim of a connected storage container are always lifted to the same level relative to the vehicle independent of the height of the storage container. This is to ensure that the bottom of a storage container having a maximum container height is lifted clear of the rail system before the container handling vehicle is moved. A potential disadvantage of the prior art container handling vehicles is however revealed when using storage containers being lower than the maximum container height for which the container handling vehicle is configured. The lower storage containers are then lifted higher than the minimum height required to be clear of the rail system. Lifting a storage container higher than necessary is both time and energy inefficient.

The present invention provides container handling vehicles being both time and energy efficient independent of the height of the storage containers being used.

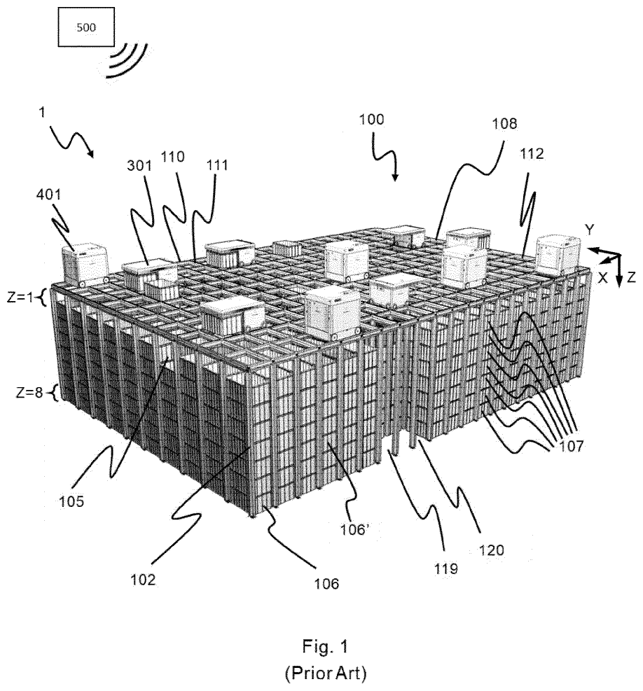

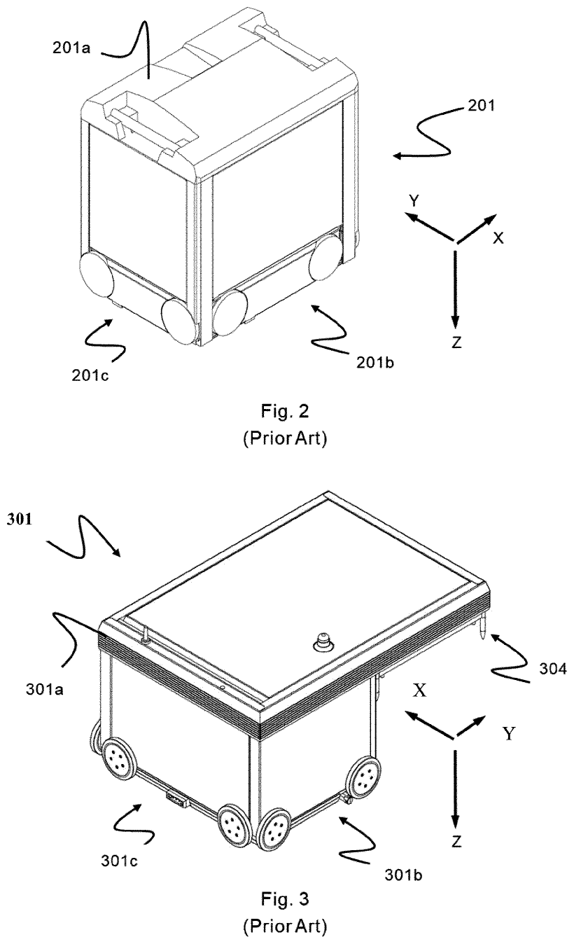

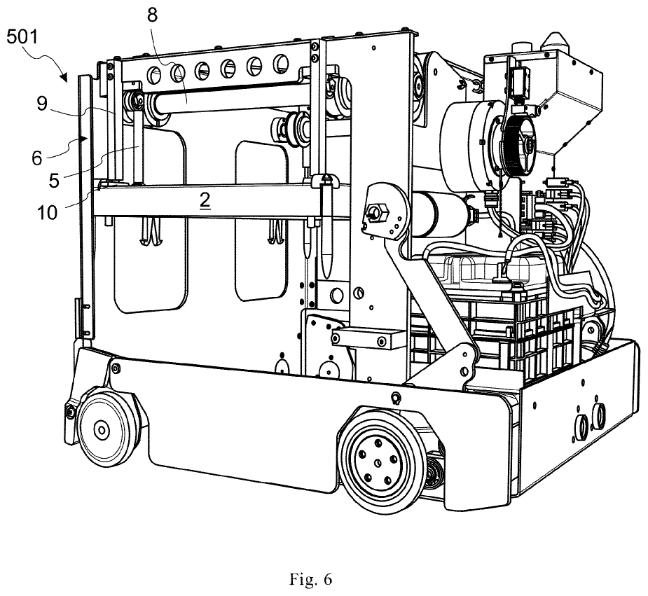

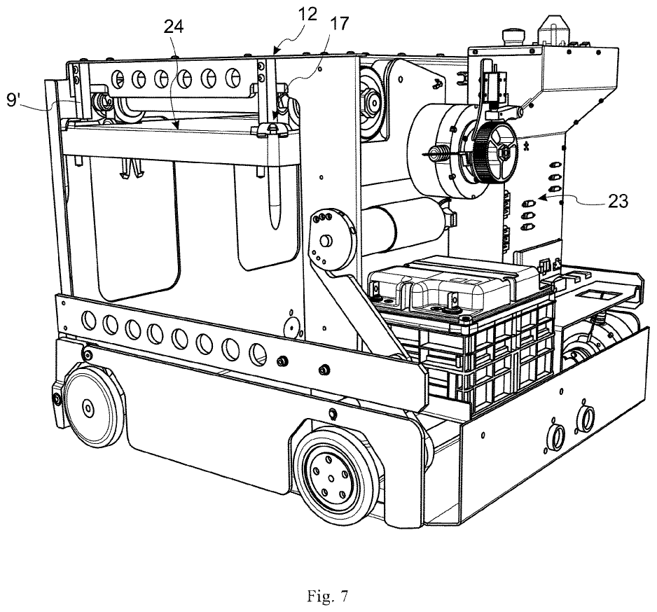

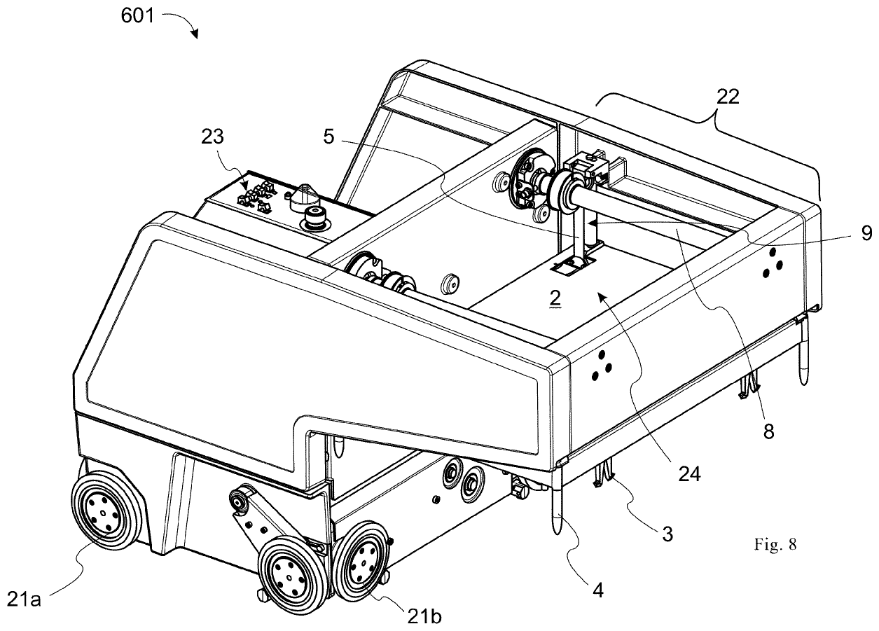

A first exemplary container handling vehicle 501 is shown in FIGS. 6 and 7. The container handling vehicle 501 is intended for a prior art storage system as shown in FIG. 1. Like the prior art vehicles, the container handling vehicle 501 is for retrieving or storing storage containers and comprises a vehicle body 6 and a first and a second set of wheels enabling movement of the container handling vehicle in the first direction X and in the second direction Y, respectively.

The container handling vehicle feature a lifting device for lifting a storage container 106 from the storage columns 105. The lifting device comprises a horizontal lifting frame 2 suspended from the vehicle body 6 by a plurality of lifting bands 5, the lifting bands are connected to at least one rotatable lifting shaft 8 such that the lifting frame 2 may be moved in a vertical direction between an upper position and a lower position relative to the vehicle body 6.

To ensure that the lifting frame is at a desired level when in the upper position, the container handling vehicle features a lifting frame stopper arrangement. The lifting frame stopper arrangement comprises a plurality of pins 9 (i.e. first stoppers) connected to the vehicle body 6 at positions above the lifting frame 2, and a plurality of cooperating sensor switches 10 (i.e. second stoppers) arranged at an upper face 24 of the lifting frame 2. Each of the pins 9 and the cooperating sensor switch 10 are configured to engage with one another to stop vertical upward movement of the lifting frame when the lifting frame is in the upper position.

The pins 9 and the sensor switch 10 ensure that the operational efficiency of the container handling vehicle 501 may be optimized with respect to the height of the storage containers 106 being lifted. If the container handling vehicle 501 is to be used for lower or higher storage containers, shorter or longer pins, respectively, may be installed to ensure that the storage containers 106 are not lifted higher than required. In FIG. 7, the pins 9 in FIG. 6 have been replaced by shorter pins 9′. In other embodiments, the same result may be obtained by e.g. replacing the sensor switches 10 with similar ones having a different height, or by having extendable/retractable pins (e.g. telescopic pins).

Each of the pins 9 has a first end 12 and a second end 17. The pins are connected to the vehicle body 6 at their first end 12 and the second end 17 is arranged for interaction with the cooperating sensor switch 10 when the lifting frame 2 is in the upper position.

The sensor switches 10 are coupled with sensors (not shown) for detecting when the pins 9 and the sensor switches engage one another. The sensor may be in communication with a control system 23 of the vehicle 501 such that rotation of the at least one rotatable lifting shaft 8 is stopped when the lifting frame is in the upper position.

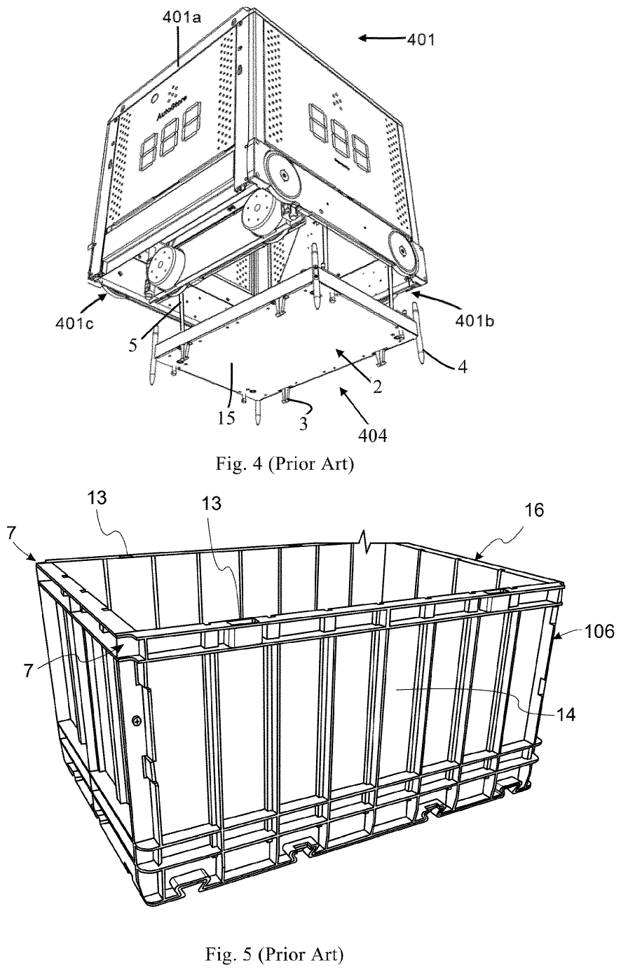

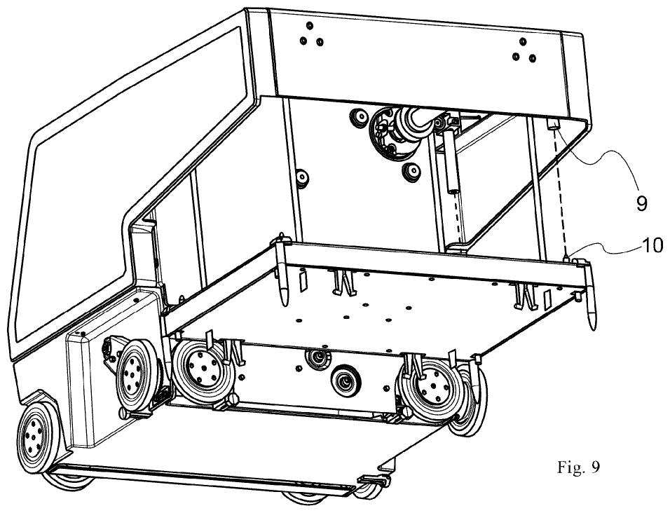

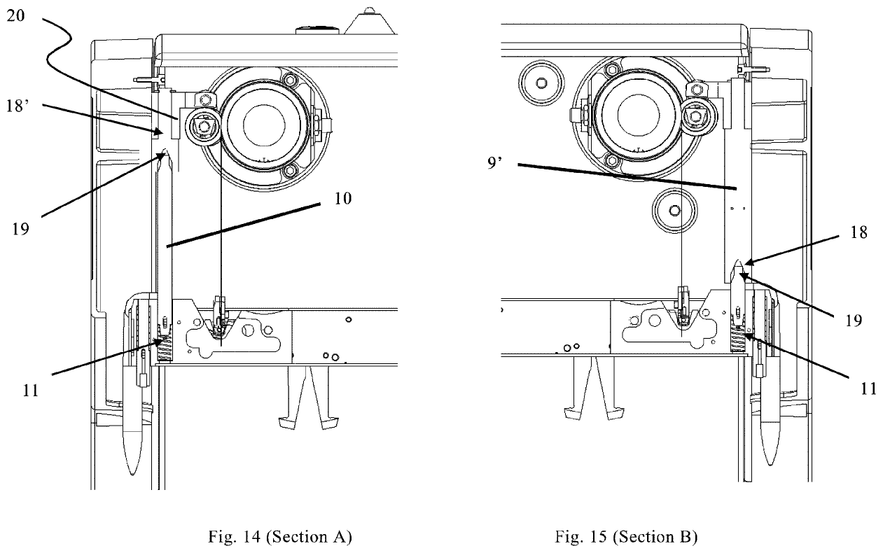

A second exemplary container handling vehicle 601 is shown in FIGS. 8-11 and 14. In the second embodiment, the vehicle body 6 comprises a cantilevered section 22 below which the lifting frame 2 is suspended, i.e. similar to the prior art container handling vehicle 301 in FIG. 3. The vehicle 601 has a first and a second set of wheels 21a,21b enabling movement of the container handling vehicle in the first direction X and in the second direction Y, respectively.

Similar to the first exemplary container vehicle in FIGS. 6 and 7, the second exemplary container handling vehicle features a lifting frame stopper arrangement to ensure that the lifting frame is at a desired level when in the upper position. The lifting frame stopper arrangement comprises a plurality of pins 9 connected to the vehicle body 6 via brackets 20 at positions above the lifting frame 2 (i.e. the pins and brackets provide first stoppers), and a plurality of cooperating sensor switches 10 (i.e. second stoppers) arranged at an upper face 24 of the lifting frame 2. Each of the sensor switches comprises a spring-loaded pin 10 coupled to a sensor 11. Each of the pins 9 and the cooperating sensor switch 10 are configured to engage with one another to stop vertical upward movement of the lifting frame when the lifting frame is in the upper position.

A second end 17 of the pin 9 comprises a recess 18 or tip configured to interact with a corresponding tip 19 or recess, respectively, of the spring-loaded pin 10, such that horizontal movement of the lifting frame 2 relative to the vehicle body 6 is prevented when the lifting frame is in the upper position.

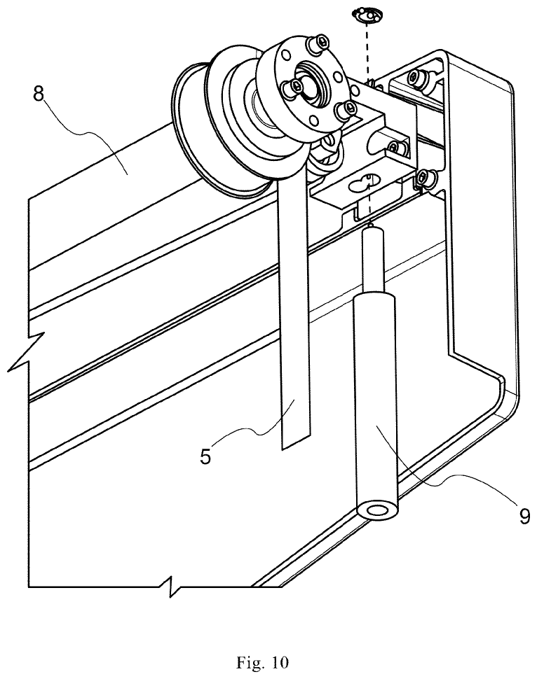

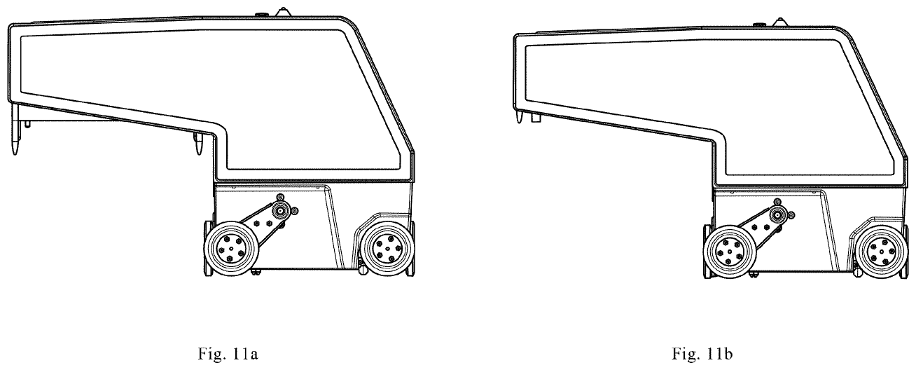

The pins 9 are releasably connected to the brackets 20, see FIG. 10, and may easily be replaced by similar pins having a different length or removed. A side view of the container handling vehicle in FIG. 8 having the lifting frame in the upper position is shown in FIG. 11a. A side view of the same vehicle featuring shorter pins 9 is shown in FIG. 11b.

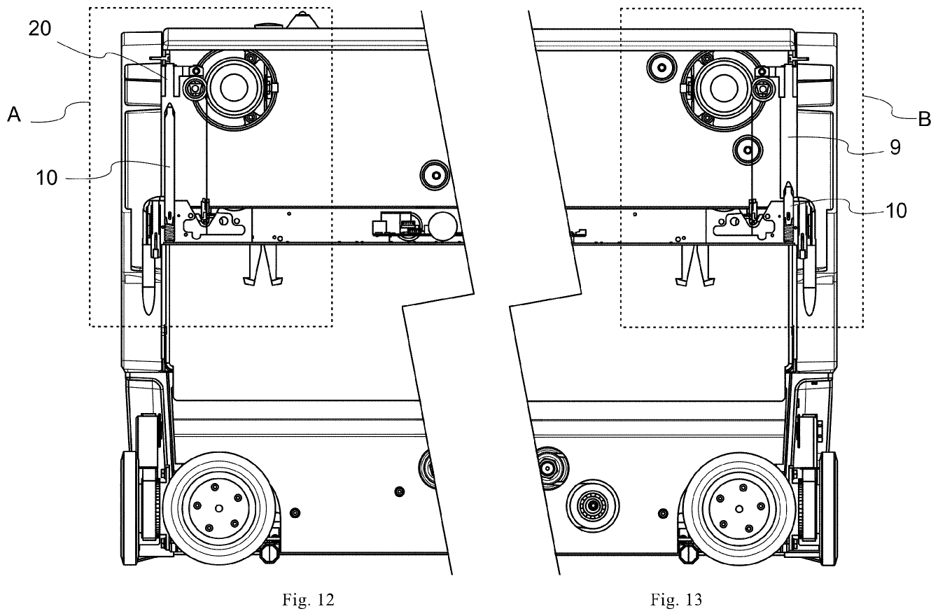

A third exemplary container handling vehicle 601 is partly shown in the left half of FIG. 12, and in FIG. 13. The vehicle 601 is similar to the second exemplary container handling vehicle, and the main difference is that the pin 9 is removed and the spring-loaded pin 10 is releasably attached to the lifting frame and may easily be replaced by similar spring-loaded pins having a different length.

### LIST OF REFERENCE NUMBERS

1 Prior art automated storage and retrieval system
2 Lifting frame
3 Container connector
4 Guiding pin
5 Lifting bands
6 Vehicle body
7 Guiding pin recess
8 Rotatable lifting shaft
9 First stopper, pin
10 Second stopper, pin
11 Sensor
12 First end
13 Connecting recess in upper rim of storage container
14 Sidewall of storage container
15 Lower bottom surface of lifting frame
16 Upper rim of storage container
17 Second end
18 Recess
19 Tip
20 First stopper, bracket
21a,21b First and second set of wheels
22 Cantilevered section
23 Control system
24 Upper face
100 Framework structure
102 Upright members of framework structure
103 Horizontal members of framework structure
104 Storage grid
105 Storage column
106 Storage container
106′ Particular position of storage container
107 Stack
10 Rail system
110 Parallel rails in first direction (X)
110a First rail in first direction (X)
110b Second rail in first direction (X)
111 Parallel rail in second direction (Y)
111a First rail of second direction (Y)
111b Second rail of second direction (Y)
112 Access opening
119 First port column
120 Second port column
201 Prior art container handling vehicle
201a Vehicle body of the container handling vehicle 201
201b Drive means/wheel arrangement, first direction (X)
201c Drive means/wheel arrangement, second direction (Y)
301 Prior art cantilever container handling vehicle
301a Vehicle body of the container handling vehicle 301
301b Drive means in first direction (X)
301c Drive means in second direction (Y)
401 Prior art container handling vehicle
401a Vehicle body of the container handling vehicle 401
401b Drive means in first direction (X)
401c Drive means in second direction (Y)
Y Second direction
Z Third direction

1-14. (canceled)

15. A container handling vehicle for picking up storage containers in a storage system, the storage system comprising a framework structure having a plurality of storage columns for accommodating a vertical stack of storage containers, and a rail system upon which the vehicle may move in two perpendicular directions above the storage columns, the container handling vehicle comprising a vehicle body and at least one lifting device for lifting a storage container from any of the storage columns;
the lifting device comprises a horizontal lifting frame suspended from the vehicle body by a plurality of lifting bands, the lifting bands are connected to at least one rotatable lifting shaft such that the lifting frame may be moved in a vertical direction between an upper position and a lower position relative to the vehicle body;
the container handling vehicle features a lifting frame stopper arrangement comprising a plurality of first stoppers connected to the vehicle body at positions above the lifting frame and a plurality of cooperating second stoppers arranged at an upper face of the lifting frame; and
each of the first stoppers and the cooperating second stopper are configured to engage one another to stop vertical upward movement of the lifting frame when the lifting frame is in the upper position.

16. A container handling vehicle according to claim 15, wherein at least a part of each first stopper or each second stopper is removeable, or replaceable by a corresponding part having a different height, or each of the first stopper or second stopper is extendable in a vertical direction, such that the level of the lifting frame when in the upper position may be adjusted.

17. A container handling vehicle according to claim 15, wherein at least one of the first stoppers or the second stoppers is coupled with a sensor for detecting when the first and second stopper engage one another; the sensor being in communication with a control system of the vehicle such that rotation of the at least one rotatable lifting shaft is stopped when the lifting frame is in the upper position.

18. A container handling vehicle according to claim 15, wherein each of the first stoppers comprises a pin having a first end and a second end, the pin being connected to the vehicle body at the first end and the second end being arranged for interaction with the cooperating second stopper when the lifting frame is in the upper position.

19. A container handling vehicle according to claim 15, wherein the vehicle body comprises a cantilevered section below which the lifting frame is suspended.

20. A container handling vehicle according to claim 15, wherein the each of the first stoppers and the corresponding second stopper are configured for sliding engagement, such that horizontal movement of the lifting frame relative to the vehicle body is prevented when the lifting frame is in the upper position.

21. A container handling vehicle according to claim 18, wherein the second end of the first stopper comprises a recess or tip configured to interact with a corresponding tip or recess, respectively, of the second stopper, such that horizontal movement of the lifting frame relative to the vehicle body is prevented when the lifting frame is in the upper position.

22. A container handling vehicle according to claim 15, wherein the second stopper comprises a spring-loaded pin, the pin being connected to a sensor for detecting when the first stopper and the second stopper is in engagement and the lifting frame is in the upper position.

23. A container handling vehicle according to claim 15, wherein the lifting frame comprises gripper elements for releasable connection to a storage container, wherein each corner of the lifting frame is provided with a second stopper.

24. A container handling vehicle according to claim 15, wherein the first stopper comprises a bracket connected to the vehicle body.

25. A container handling vehicle according to claim 18, wherein the pin is releasably attached to a bracket.

26. A storage system comprising a container handling vehicle according to claim 15, a framework structure having a plurality of storage columns accommodating a vertical stack of storage containers, and a rail system upon which the vehicle may move in two perpendicular directions above the storage columns.

27. A storage system according to claim 26, wherein at least a part of each first stopper or each second stopper is removeable, or replaceable by a corresponding part having a different height, or each of the first stopper or second stopper is extendable in a vertical direction, such that the level of the lifting frame when in the upper position may be adjusted between a first level and a second level, the first level being higher than the second level;
the storage containers may be of a first type or a second type, the first type and the second type having a height difference;
the height difference being equal to a height difference between the first level and the second level.

28. A method of optimizing a container handling vehicle for use in a storage system according to claim 27 in which vertical stacks of the first type of storage containers are to be replaced by vertical stacks of the second type of storage containers; the method comprising the steps of:
adjusting the level of the lifting frame when in the upper position from the second level to the first level by:
removing at least one part of the first stopper or the second stopper; or
replacing at least one part of the first stopper or the second stopper by a corresponding part having a different height; or
retracting at least one part of the first stopper or the second stopper in a vertical direction.
